(19) United States
(12) Patent Application Publication
(10) Pub. No.: US 2004/0152517 A1
(43) Pub. Date: Aug. 5, 2004

(54) Internet based multiplayer game system

(76) Inventors: Yon Hardisty, San Leandro, CA (US); Tracy Edgecomb, Berkeley, CA (US); Jean A. Ames, Los Osos, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/734,669

(22) Filed: Dec. 11, 2003

Related U.S. Application Data
(63) Continuation of application No. 09/503,860, filed on Feb. 14, 2000, now abandoned.

(51) Int. Cl. G06F 17/60; A63F 9/24; A63F 13/00; G06F 17/00; G06F 19/00; G06F 15/16

(52) U.S. Cl. 463/42; 705/14; 709/205

(57) ABSTRACT

A multi-player computer game system using presence servers to determine the online availability of selected users with whom games are played. The game software interrogates messaging software in communication with the presence server to determine the availability of online users. The game software then communicates with game software of the online users to determine game availability. Users thereafter play games with other online users who have similar game availability.

### BACKGROUND OF THE INVENTION

The present invention relates generally to computer games, and more specifically to multi-player computer games played over the Internet.

Computers have long been used to provide games to users. Millions of people have been entertained by playing games using computers, with the games ranging from a relatively simple game of solitaire to complex games providing extensive realistic graphical displays. Many computer games merely allow users to play games that do not generally require use of a computer. For example, the game of solitaire could be played with a deck of cards rather than a computer. In other games, users play against the computer, namely the computer provides an opponent to provide a test of skill for the user.

Playing against the computer, however, is not always optimal. A computer opponent only provides a indirect method for determining the results of competition between individuals. A computer opponent may also lack the realism of the actions which would be undertaken by an individual opponent. In addition, playing against the computer is generally a solitary sport. If the user desires to discuss aspects of the games during or after a game, the computer is generally unresponsive and therefore the total potential entertainment experience of the game may be left unfulfilled.

Multi-player games have been played either by connecting two computers together via a serial or parallel data line, or through the use of a modem and telephone lines, including the Internet. Some computer games now provide access to a system allowing individuals to play computer games on-line against one another. These systems, however, do not provide a perfect panacea. Often little is known about the person a user is playing a computer game against. For example, often all a user knows about the user's opponent is a “user name” provided by the opponent. The user does not have knowledge regarding the opponent's skill level, experience, or personal traits. In effect, the opponent is often a complete stranger. Thus, outside of the actual game, the user is provided little opportunity for interaction with the opponent. Further, because the opponent is likely a stranger, there is little likelihood of a shared experience for discussion and analysis.

Arranging to play a friend on-line, however, can be difficult. Details regarding what to play, when to play, and how to arrange for communication between computers may not be simple or easy. The logistical hurdles in setting up such a game detract from the game experience, and also act as a barrier against multi-player game playing. In addition, many computer games are long and involved. The length and complexity of these computer games also serves to prevent spur of the moment game playing.

### SUMMARY OF THE INVENTION

The present invention therefore provides a multi-player game system. In one embodiment, the present invention comprises a method performed by a computer for multi-player game play over the Internet. The method includes receiving a selection of a game for play, the selection being performed by a user. The method further comprises querying a presence server for available opponents in response to receipt of the game selection, the available opponents being from a predefined list prepared by the user, and presenting the available opponents to the user. The method additionally comprises receiving a selected opponent, the selected opponent being selected by the user, and transmitting a message to the selected opponent requesting to play the selected game, and beginning play the selected game with the selected opponent.

In another embodiment, the present invention comprises a method of selecting an opponent for multi-machine multi-player computer game play comprising providing a list of available games and receiving a game selections of one of the available games. In addition, the method comprises determining a list of available game opponents, the list of available game opponents being determined by interrogating a software module in communication with a presence server, the software module maintaining information regarding specified users. The method additionally comprises receiving an opponent selection of a specified user and transmitting a request to play a game to the specified users.

In another embodiment of the present invention, the present invention comprises a system for playing a game between at least two devices, comprising a first user device, a second user device, a game server, an advertising server and a presence server. The first user device, the second user device, game server, advertising server being linked by a remote communication link. The first user device and the second user device having messaging software in communication with the presence server and game playing software on the other user device.

These and other aspects of the present invention will be more readily understood with reference to the following detailed description and with the accompanying drawings.

### DESCRIPTION OF THE DRAWINGS

FIG. 1 is a block diagram of a system of an Internet based multiplayer game in accordance with an embodiment of the present invention;

FIG. 2 is a block diagram of a user device of a system of an Internet based multiplayer game in accordance with an embodiment of the present invention;

FIG. 3 is a flowchart of an overview of the process of executing a multiplayer game system in accordance with an embodiment of the present invention;

FIG. 4 is a flowchart of a process of determining game availability of the present invention;

FIG. 5 is a flowchart of a process of soliciting an online user for game play;

FIG. 6 is a flowchart of a process of transmitting game data to an online user in accordance with the present invention;

FIG. 7 is a flowchart of a process of receiving game data from an online user in accordance with the present invention;

FIG. 8 is a screen shot showing a game and ad banner of the present invention; and

FIG. 9 is a flowchart illustrating an advertisement process of the present invention.

### DETAILED DESCRIPTION OF THE INVENTION

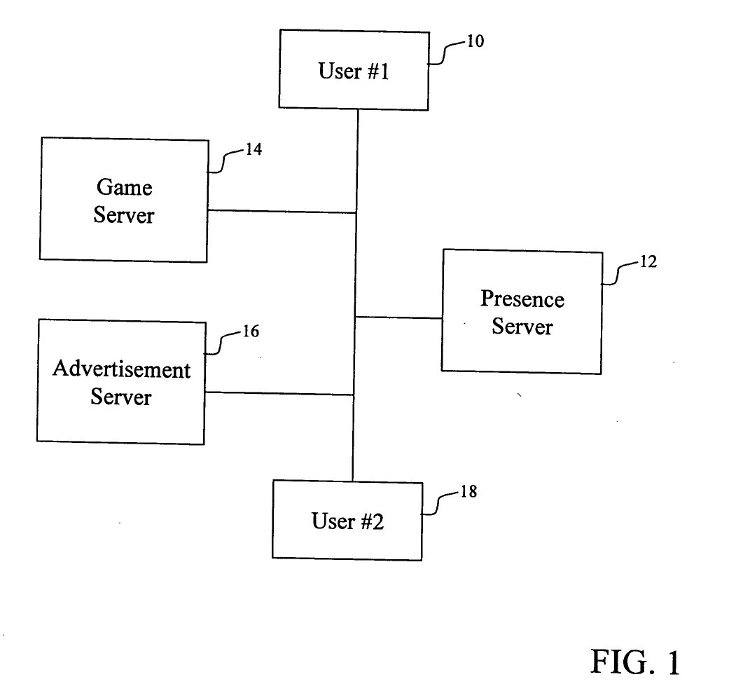

A multiplayer game system in accordance with the present invention is illustrated in FIG. 1. The system of FIG. 1 includes a first user device 10 and a second user device 18. In the system of FIG. 1, the first user device and the second user device comprise a personal computer having a display monitor and a data entry device, e.g., a keyboard or mouse that directs operation of the computer.

The first user device and the second user device are coupled to a remote communication link 11. The first user device and the second user device communicate with each other over the remote communication link. In the embodiment of FIG. 1 the remote communication interface is the Internet. Accordingly, the remote communication link, in actuality, includes multiple computer units, and data packets from the user devices are routed through various computer units while being transferred between the user devices. In alternative embodiments the remote communication link comprises an Intranet or other computer-to-computer link.

Also coupled to the remote communication link is a presence server 12. The presence server communicates with the user devices to track which devices are connected to the remote communication link. The associated hardware and/or software at the presence server site comprises a modem, an HTML server and database software. The presence server tracks which users are online and how they can be communicated with. Thus, when a user device connects to the remote communication link, the user device provides information to the presence server. The information includes an identity of the user device and a location of the user device. In the embodiment of FIG. 1, the identity is a user name of a user using the user device, and the location is the IP address of the user device. Thus, the information provided to the presence server allows other devices that communicate with the presence server to obtain information from the presence server as to whether a user device is connected to the remote communication link and how to communicate with a connected user device.

A game server 14 is also connected to the remote communication link. The game server contains game playing software as well as associated games. The game server provides game and interface software to user devices to allow users using the user devices to play computer games against one another. More particularly, and as described in more detail below, the game server is a web server which provides HTML input forms to user devices, receives responses to the input forms, and acts upon the received responses through execution of common gateway interface (CGI) scripts or programs. If user devices so request, the game server provides the game playing software and games.

Further, an advertising server 16 is also connected to the remote communication link. The advertising server communicates with user devices to transfer advertising content that is displayed on a portion of the user device screen during a game. The advertising server has a modem, a file server, advertisement information, and database software. The game playing software on a user device accesses the advertisement server to acquire advertisement content to be displayed during a game. In one embodiment of the present invention, the advertisement server is a component of the game server.

When game play is initiated on a user device, game playing software requests advertising content from the advertisement server. The advertisement server selects advertisements to send to the user. In a preferred embodiment of the present invention, the advertisement server selects advertisement content based on demographic information about the user. For example, the advertising server is provided with geographic information based on where the user device is contacting the advertising server from. Once the advertisement server selects an advertisement to transmit to the user, the advertisement selection software sends the advertisement content over the remote communication link to the user device.

In one embodiment of the present invention, the game playing software tracks the number of times that a given advertisement is displayed on a user device. The game playing software transmits information about the advertisements displayed on the user device to the advertising server. The advertisement server places the information into a database for tracking and billing purposes. In an embodiment of the present invention advertisers or others may request information about advertisement display from the advertisement server.

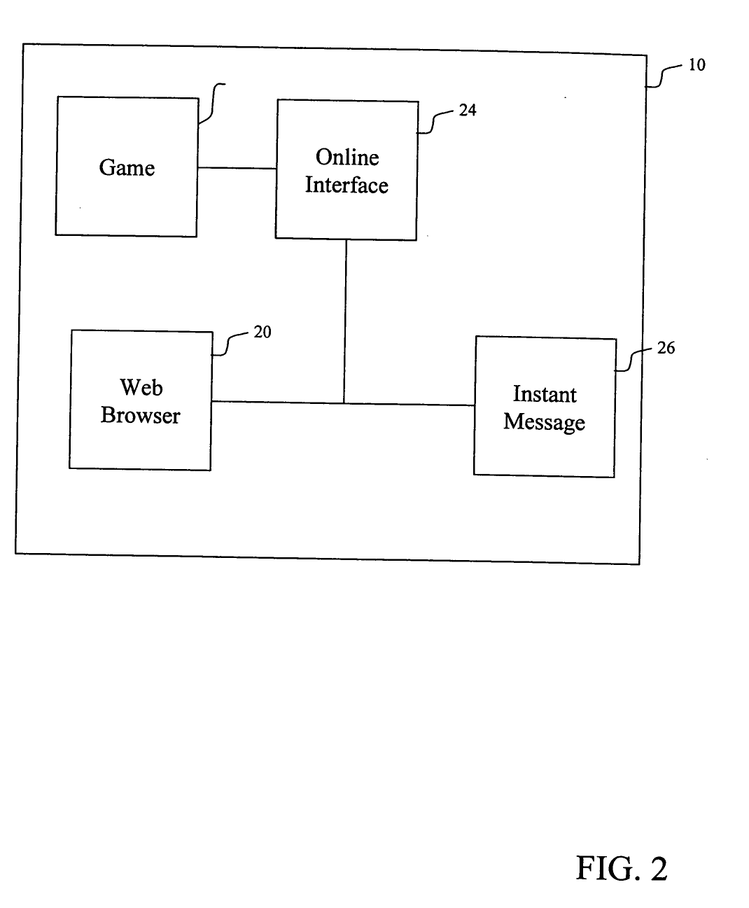

FIG. 2 illustrates a block diagram of software resident on a user device. The user device 10, in operation, contains many more software programs, modules, and the like, such as operating system software. For clarity of description of the present invention, however, only a few modules or programs are illustrated. As shown in FIG. 2, the software on the user device includes a web browser 20 such as Internet Explorer from Microsoft Corp. or Netscape Navigator or Communicator from Netscape. The web browser is an HTML capable user interface. The user devices also include a game module 22, an online interface module 24 and an instant message module 26.

The game module 22 performs game logic functions to allow for playing of computer games. The game module provides a display window forming a user interface, and executes game logic in response to user inputs or inputs received from the online interface module. The game module also provides game status information to the online interface module for transfer over the remote communication link to the other user device.

The online interface module 24 determines, in conjunction with the instant message software discussed below, the availability of other users and coordinates the transfer of information to and from other users during game play. More specifically, the online interface module extracts information from the instant message module as to the availability of a predefined set of users, compares the information regarding available users with a list of game capable users, and generates a list of game capable available users for display in a window generated by the online interface module. The online interface module thereafter coordinates information transfer between user devices to select and play games.

The instant message module 26 communicates via the remote communication link with the presence server. The instant message module notifies the presence server that a user using the user device is connected to the remote communication link and provides the presence server with the information necessary, i.e. a URL, for other users to send information to the user's device.

When the instant message module is commanded to terminate execution by the user, the instant message module transmits a status message to notify the presence server that it is being terminated and that the user is no longer online, i.e. no longer connected to the remote communication link. Alternatively, if the instant message module is unexpectedly terminated, the lack of a response to queries from the presence server leads the presence server to conclude that the instant message module terminated and that the user is not online.

The instant message module also transmits requests for the status of identified online users to the presence server. The transmission is accomplished either at the explicit command by the user, or by way of a request by other modules executing on the user device. The transmission includes a list of users. Thus, the instant message module determines, through the presence server, whether a preidentified set of users are online.

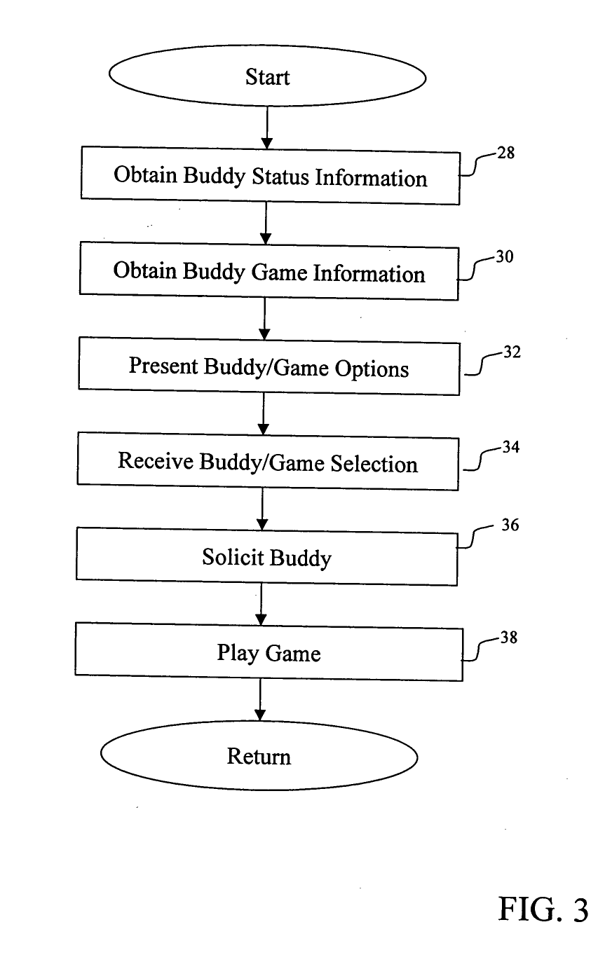

FIG. 3 illustrates a flow diagram of an overview of a process executing on a user device in accordance with the present invention. In the process of FIG. 3, information is obtained regarding available users with which games may be played, a selected user is solicited to play a game, and the game is played.

Accordingly, the process obtains the online status of a list of preidentified users (28). In one embodiment the process receives a predefined list of user names. The user names are provided by a user using the user device. The list of user names is transmitted by the process to a presence server, along with a request for the status of the users on the list. The presence server, which maintains the online status of users, responds with information as to whether each user on the list of user names is currently online, and if so their IP address. The users which are currently online are online users. As each of the online users is from the list provided by the user of the user device, and such a list is sometimes termed a buddy list, the online users may be termed online buddies.

In a preferred implementation, obtaining the online status of the list of users is accomplished using an instant message module. Examples of instant message modules include Yahoo Messenger and AOL Instant Messenger. Such modules, which communicate with proprietary presence servers, are widely available. A user may have more than one instant message module on their device. In a preferred embodiment of the present invention information is gathered from all of the instant message modules to form a master list of online buddies. Alternatively, each of the different presence servers associated with each of the instant message modules are polled as described above to determine which buddies are online.

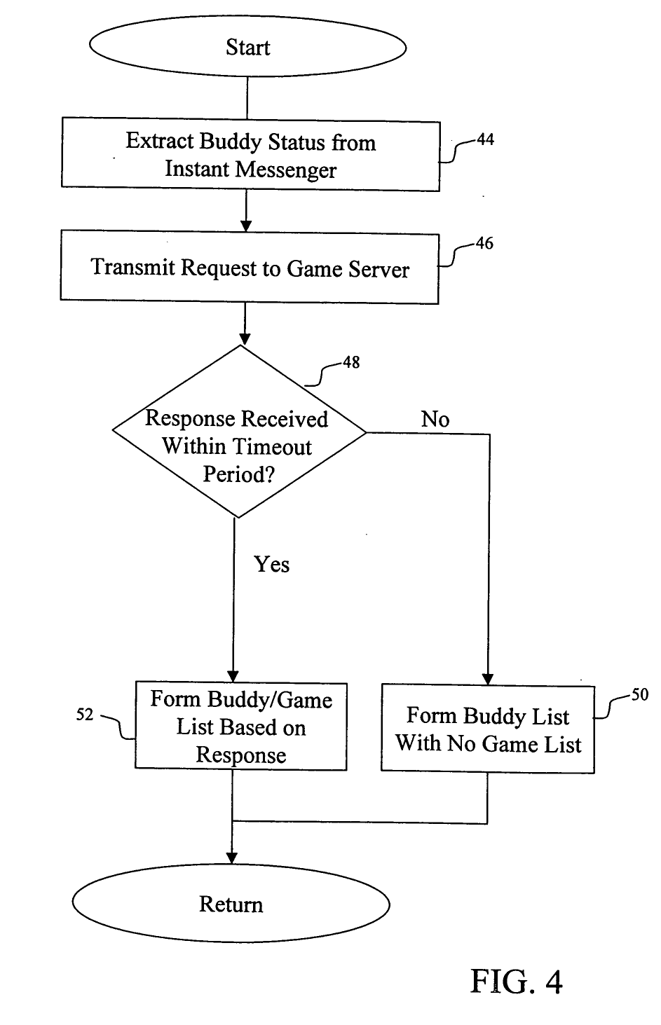

The process also determines the games that each online buddy is able to play (30), i.e., games associated with each online buddy. FIG. 4 illustrates a process of determining games associated with each online buddy. In the process of FIG. 4, data is extracted from the instant message module (44) regarding the status of the users identified by user name, and forms a list of online buddies. The process then transmits the identities of the online buddies to a game server (46). The game server contains a database of everyone who downloads the game interface software. Each time a user downloads a new game an entry is made into the database so that another user can request information about which games a particular user has. The transmission of the identity of the online buddies is part of a request to the game server, with the request being that the game server indicate the games associated with each online buddy. The process thereafter waits to receive a response from the game server (48). If no response is received within the time out period the process forms an online buddy list with no indication of available games (50). If, however, the game server indicates the games associated with each online buddy, then the process generates a list of online buddies and associated games based on the game server's response (52). The process thereafter returns.

In an alternative embodiment, the process does not determine whether a particular online buddy has a particular game by interrogating the game server. Instead, information about which games an online buddy has is provided by the presence server to an instant message module resident on each user device. The information concerning the games a user has is maintained by the presence server. Therefore, the presence server indicates to the instant message module not only a user name and an IP address, but additionally indicates the games an online user is able to play. Thus, a separate request to the game server is not required as information regarding game availability for online buddies is readily available from the instant message system. Further, as it is possible that some users may obtain games from other than the game server, incorporating information regarding game availability in the messages to the presence server potentially increases system data accuracy.

In another alternative embodiment, each user device maintains a log of games played against online buddies. Specifically, each user device stores a file in memory indicating the games associated with each buddy. This allows each individual user device to maintain data regarding which online buddies have which games. In alternative embodiments the user device also tracks the number of games played against a particular buddy which games were played, the results of the contests, as well as other acquired personal information about the buddy.

In another alternative embodiment, the determination of games is done peer to peer. The process extracts data from the instant message module and forms a list of online buddies. Once location information is obtained from the instant message module, the process contacts each individual's computer to establish a connection. Initially, the process notifies a buddy's device that the user has the game software executing, and asks the buddy's device to return a response if the game software is executing on the buddy's device. Once the user's device receives a response that the buddy's device is executing the game software, the game software on the user's device transmits a message listing the games installed on the user's device, and requests a list of the games installed on the buddy's device.

Returning now to FIG. 3, the process presents the list of online buddies and associated games to the user (32). This is done by way of a pop up window in which a buddy and an associated game are selectable. The user may wish, however, to play a particular game with a particular online buddy, although the online buddy does not have the particular game associated with the online buddy. In addition, in the event the game server is unavailable the online buddies will have no associated games. Accordingly, the process additionally presents a list of games available on the user device (34). The process thereafter receives selections by the user. Based on the user selections, the process receives an identification of an online buddy with which the user wishes to play a game, as well as the game the user wishes to play.

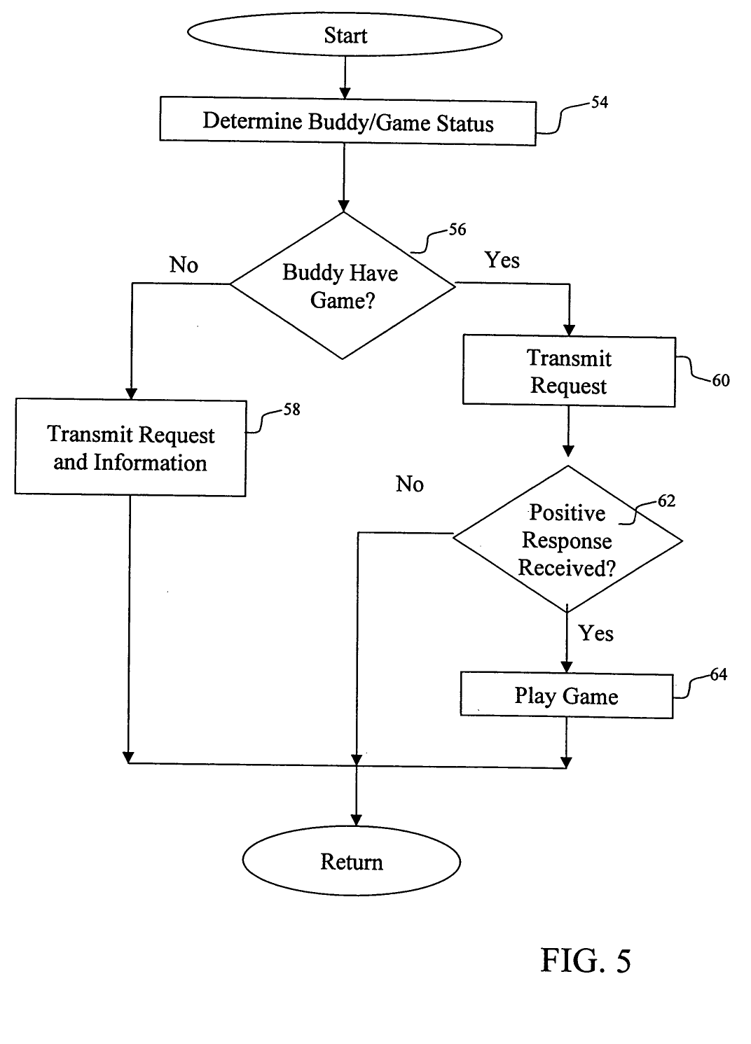

The process thereafter solicits the online buddy to play the game (36). The nature of the solicitation to the online buddy depends on whether the online buddy has the selected game. FIG. 5 illustrates a process of soliciting an online buddy to play a game. The process first determines the identity of the online buddy and the selected game (54). This is accomplished as a result of receiving the online buddy and game selection accomplished by the user. The process then determines if the online buddy has the selected game (56). If the online buddy does not have a selected game the process transmits a request to the online buddy to play the game, as well as including information as to how the online user may obtain a game to allow for play (58). In the described embodiment, the information includes a link to the game server. The link includes a URL of the game server. The URL provided is for a specific file residing on the game server which is an HTML file viewable by a browser. The HTML file includes options to identify whether a recipient of the HTML file requires merely a single game or a game as well as the interface module. After appropriate input by the recipient, the recipient's user device provides the requested information to the game server by way of a post, although alternatively a get may be used. The game server thereafter executes a CGI script or program which transfers the requested programs to the recipient user device. The process thereafter returns.

If the online user does have the selected game, the process transmits a request to play the game (60). The process thereafter waits to receive a response (62). If a positive response is received within a timeout period the process begins to execute the game program and to play the game (64); if no positive response is received within a time out period, the process returns. As part of game play, the process logs both the user and buddy onto a server transparently to track the number of people playing games, the time each game is played and the advertisements displayed.

During game play the online interface module processes and monitors game related communication. The online interface monitors the user's Internet connection and the user's instant messenger buddy lists. As information packets containing game information are sent through a network from user to buddy, the online interface keeps track of interruptions to a player's Internet connection. The online interface scans for returned information packets. If a packet is returned to a user or buddy, the packet contains information about how far into the Internet the packet went before being returned. The online interface provides an error message to the player that explains where the network connection failed as well as possible reasons and solutions.

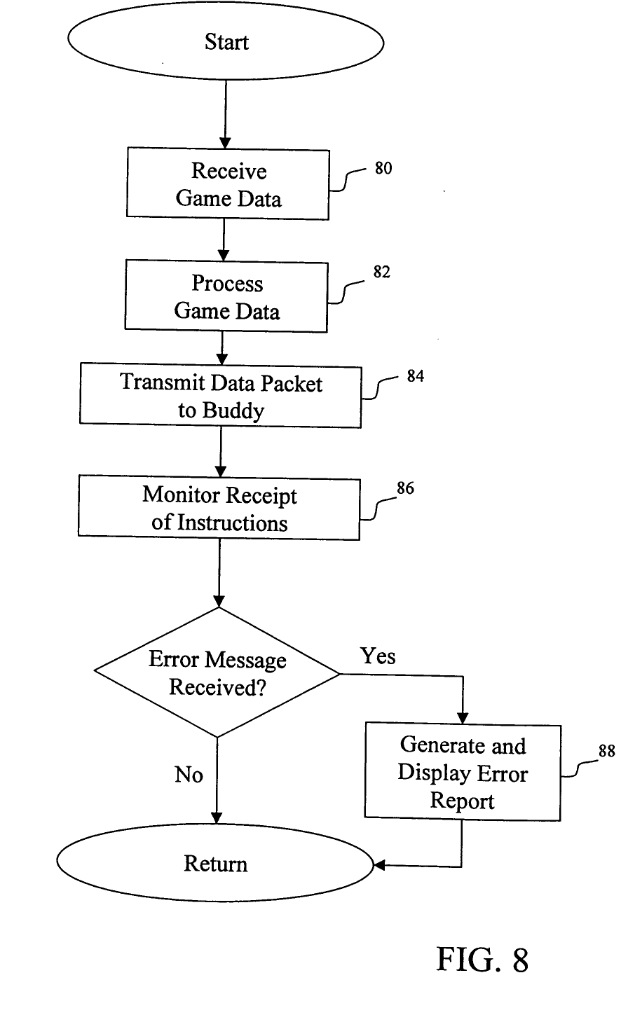

A process of how the online interface module transfers data from the game module to an online buddy during game play is illustrated in FIG. 8. The process receives game data from the game module (80). The process processes the game data into data packets to be passed to the buddy's device so that a game module on the online buddy's device can render the game changes caused by the user (82). The process then transmits the data packets to the online buddy's device (84). After the instructions have been transmitted the process monitors the user device network connection to determine if any error messages pertaining to the data transfer are received (86). If an error message is received (87) then the process pauses the game and generates an error message allow the user to remedy the problem (88).

There are several reasons why instructions may not reach the device of the online buddy and different error messages are provided to the process depending on the nature of the error. If, for example, the modem of the user device is not functioning properly, an error message is generated by the operating system on the user device. Alternatively, if the remote communication link is not functioning properly the instructions may be returned to the user's device with information about where in the network the information transmission stopped. Based on the error message received by the online interface, the online interface stops game play and generates an error message for the user, so that the user knows what the problems are.

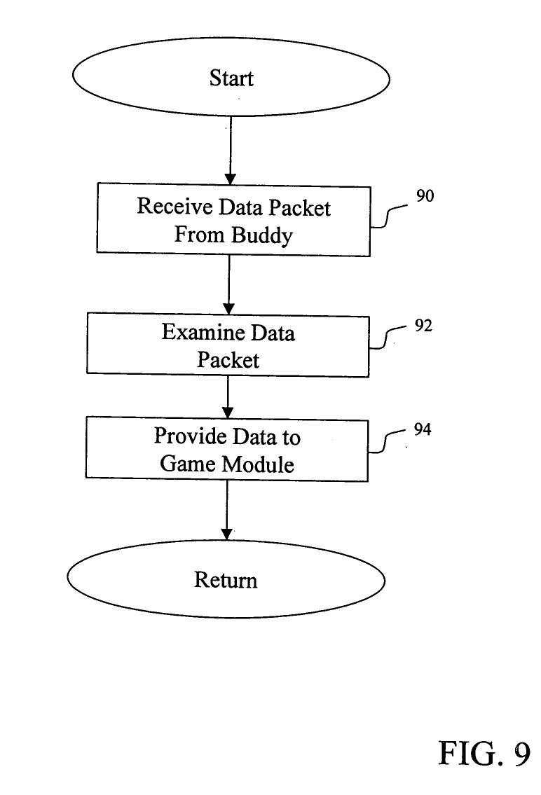

A process of the online interface for receiving data from the online buddy is illustrated in FIG. 9. The process receives data transmitted over the remote communication link from the online buddy (90). The process examines received data packets to determine the location of the source of the data packet 92. The process then compares the IP address of the source of the data packet to that of the online buddy. The process then transmits the data to the game module (94).

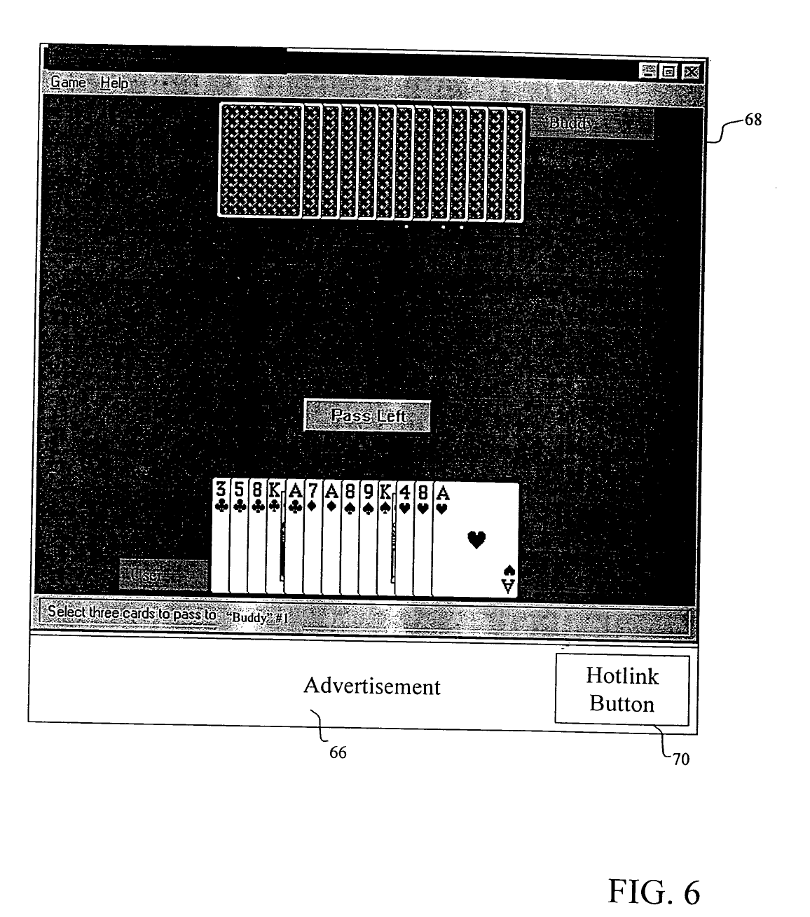

As shown in FIG. 6, once a game is initiated, the game playing software displays a windowed advertisement area 66 at one area of the screen 68. In one embodiment of the present invention, the advertisement area is located along the bottom of the screen. Advertisements cycle through the windowed area at a predetermined rate. In an embodiment of the present invention, a hotlink button 70 is placed next to the advertisement. The hotlink button opens a browser window and links to a website that corresponds to the advertisement. The button can be tailored to the specific game that is being played so that it is not intrusive or confused with game controls. In an alternative embodiment, the entire banner advertisement functions as a hotlink button, and therefore, opens a browser window and links to a website that corresponds to the advertisement.

In an embodiment of the present invention, when the player downloads the game playing software, banner advertisements are communicated to the user's device. The advertisements are displayed in the advertisement window starting at the beginning of a game and cycled throughout the game. In one embodiment of the present invention, one advertisement is displayed each minute.

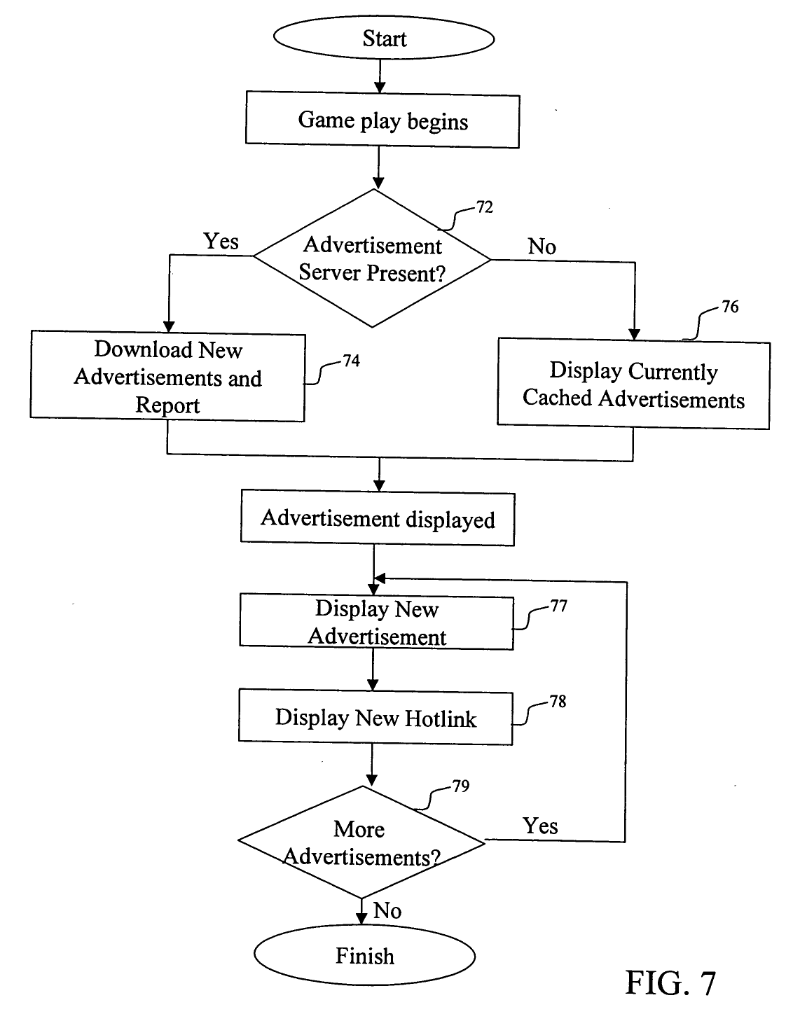

As shown in FIG. 7, the game playing software checks to see if communication with the advertisement server is possible 72. If communication is established then while the game is active, the game playing software is in communication with the advertisement server. The advertisement server tracks the number of advertisements viewed by the player at regular intervals and communicates the information of the advertisement server 74. The game playing software slowly updates the banners in the player device's memory 80 and storage so that new advertisements can be displayed.

In one embodiment of the present invention, if the advertisement server is not functioning during game play then the advertisements in memory continually replay 82 and the game playing software tracks which advertisements were displayed and the number of times each advertisement was displayed. When contact is reestablished with the advertisement server the advertisements displayed and the number of times each advertisement was displayed is sent to the advertisement server. The advertisements are then updated.

The preceding description has been presented with reference to the presently preferred embodiments of the invention shown in the drawings. Those skilled in the art and technology to which this invention pertains will appreciate that alteration and changes in the described processes and structures can be practiced without departing from the spirit, principles and scope of this invention.

Accordingly, the present invention provides for an instant messenger game playing system. Although this invention has been described in certain specific embodiments, many additional modifications and variations would be apparent to those skilled in the art. It is therefore to be understood that this invention may be practiced otherwise than as specifically described. Thus, the present embodiment of the invention should be considered in all respects as illustrative and not restrictive, the scope of the invention to be determined by the claims supported by this application and their equivalents rather than the foregoing description.

1. A method performed by a computer of performing multi-player game play over the Internet comprising:
receiving a selection of a game for play, the selection being performed by a user;
querying a presence server for available opponents in response to receipt of the selection of a game for play, the available opponents being from a predefined list prepared by the user;
presenting the available opponents to the user;
receiving a selected opponent, the selected opponent being selected by the user;
transmitting a message to the selected opponent requesting play of the selected game; and
beginning play of the selected game with the selected opponent.

2. A method of selecting an opponent for multimachine multiplayer computer game play comprising:
providing a list of available games;
receiving a game selection of a one of the available games;
determining a list of available game opponents, the list of available game opponents being determined by interrogating a software module in communication with a presence server, the presence server maintaining information regarding users logged onto a network and the software module maintaining, based on information provided by the presence server, information regarding specified ones of the users;
receiving an opponent selection of a one of the specified ones of the users; and
transmitting a request to play a game to the one of the specified ones of the users.

3. A method for playing a game between at least two devices comprising:
providing a game playing software;
configuring the game playing software to work with an instant messenger software;
connecting a user to at least one other player; and
communicating game information to at least one other player.

4. The method according to claim 3 wherein connecting a user to at least one other player comprises:
polling at least one instant messenger to determine other possible players;
communicating a list of other possible players to a user by the game playing software;
receiving by the game playing software of a player selection by the user;
sending a solicitation to the player selected asking them to join the game; and
receiving by the game playing software of a response from the player solicited.

5. The method according to claim 3 further comprising an advertising display bar whereby advertisements are displayed.

6. The method according to claim 5 wherein the advertising process comprises a hotlink button that when pressed enables communication with an advertiser.

7. The method according to claim 5 further comprising:
communicating with an advertisement server;
reporting advertisements displayed to the advertisement server; and
receiving by the game playing software of advertisements from the server.

8. The method according to claim 5 wherein at least one advertisement is obtained contemporaneously with the game playing software.

9. The method according to claim 3 wherein the solicitation to the player selected asking them to join the game further comprises:
detecting whether the player selected has the game playing software; and
making the game playing software available to the player selected.

10. The method according to claim 3 wherein game information is communicated through at least one of the Internet, an Intranet, a parallel connection, and a serial connection.

11. The method according to claim 3 wherein game information is communicated through the Internet.

12. The method according to claim 3 wherein the game playing software is provided through at least one of the Internet, an Intranet, a parallel connection, and a serial connection, e-mail, and portable storage media.

13. A system for playing a game between at least two devices comprising:
a first user device;
a second user device;
a game server;
an advertising server; and
a presence server;
the first user device, second user device, game server, advertising server and presence server being linked by a remote communication link with the first user device and second user device having messaging software in communication with the presence server and game playing software in communication with the messaging software and the game playing software on the other user device.

14. The system of claim 13 wherein the game playing software monitors the sending and receiving of game information; and
wherein the game playing software tracks interruptions to the communication between the first user device and the second user device and generates an error message for a communication problem.

15. The system of claim 14 wherein the first user device further comprises individual games.

16. The system of claim 13 wherein the game playing software polls the messenging software to determine possible game opponents.

17. The system of claim 13 wherein the game playing software creates a selectable list of possible game opponents.

18. The system of claim 13 wherein the game playing software receives a selection from a user of a possible game opponent, and using information from the messenging software contacts the possible game opponent.

19. The system of claim 18 wherein the game playing software determines whether the possible opponent has the game playing software on the possible opponent's device;
the game playing software sends possible opponents without the game playing software instructions on how to obtain the game playing software; and
the game playing software sends possible opponents with the software instructions on how to join the game.

20. The system of claim 14 wherein the game playing software displays advertisements during game play.

21. The system of claim 13 wherein the first user device further comprises an Internet navigator that is usable by the game playing software.

22. The system of claim 13 wherein the remote communication link is at least one of the first user device, the second user device, the game server, the advertising server and the presence server all communicate with each other through at least one of the Internet, an Intranet, a parallel connection, and a serial connection.

23. The system of claim 13 wherein the remote communication link is the Internet.

24. The system of claim 14 wherein the game playing software tracks the advertisements displayed during a game;
sends the tracking information to the advertisement server;
receives advertisements from the advertisement server; and
stores advertisement information to a memory or storage media.
